(19) United States
(12) Patent Application Publication
(10) Pub. No.: US 2004/0002948 A1
(43) Pub. Date: Jan. 1, 2004

(54) Portable electronic device and method for determining its context

(75) Inventors: Jani Mantyjarvi, Oulu (FI); Johan Himberg, Helsinki (FI); Pertti Huuskonen, Tampere (FI)

Correspondence Address: Crawford Maunu PLLC, Suite 390, 1270 Northland Drive, St. Paul, MN, 55120, US

(73) Assignee: Nokia Corporation

(21) Appl. No.: 10/378,979

(22) Filed: Mar. 3, 2003

(30) Foreign Application Priority Data
Mar. 4, 2002 (FI) 20020412

(51) Int. Cl. G06F 7/00

(52) U.S. Cl. 707/1

(57) ABSTRACT

The invention relates to a method for determining a context of a portable electronic device, and to a portable electronic device. The portable electronic device comprises a user interface, a context, means for maintaining local context information of the first device, a short-range radio transceiver, means for receiving context information transmitted by a second portable electronic device belonging to a dynamic adhoc network determined by the coverage area of the short-range radio transceiver, and means for determining a confidence level of the context of the first device by using the local context information of the first device and the received context information of the adhoc network.

### FIELD

The invention relates to a method for determining a context of a portable electronic device, and a portable electronic device.

### BACKGROUND

A portable electronic device, e.g. a subscriber terminal of a mobile system or any other portable device relating to ubiquitous computing, contains information on its context. The context refers to information on the use of the device. The device can be aware of a device context, an environment context and a user context, for instance.

The environment context refers to information on the environment where the device is used. It is detected with various sensors placed in the device, such as a temperature sensor.

The device context refers to information on the internal state of the device, such as information on the battery charge state, information on the applications in the device, information on nearby devices, or information on telecommunication networks detected by the device.

The user context refers to information on the user's state, for instance, his location (office, home, café, street, etc.), his physical state (resting, running, sitting, walking, drinking, etc.), his mental state (tired, angry, anxious, happy, energetic, etc.) and his interpersonal state (alone, with another person, in a group, chatting, arguing, in a meeting, etc.). The user context can also be application-specific, for instance, so that at a given time, the device searches for available lunch restaurants in the vicinity and retrieves their menus to be shown by the user interface of the device.

The context is provided by sensors and settings in the device and by algorithms, which analyse data and infer the context. The objective is to make the device able to infer its context automatically, or almost automatically. In current devices the user makes context-related settings, for instance when (s)he will attend a meeting, (s)he sets on a meeting setting, and consequently an alert of an incoming call is not made by sound but by vibration, for instance. The ubiquitous computing for determining the context of a single device has not been utilized much so far.

### BRIEF DESCRIPTION

It is an object of the present invention to provide an improved method for determining a context of a portable electronic device and an improved portable electronic device.

An aspect of the invention is a method for determining a context of a portable electronic device, the method comprising: maintaining local context information in a first portable electronic device; receiving in the first electronic device context information transmitted by a second portable electronic device belonging to a dynamic adhoc network determined by the coverage area of a short-range radio transceiver of the first device; and determining a confidence level of the first device context by using the local context information of the first device and the received context information of the adhoc network.

An aspect of the invention is a portable electronic device comprising: a user interface; a context; means for maintaining local context information of a first device; a short-range radio transceiver; means for receiving context information transmitted by a second portable electronic device belonging to a dynamic adhoc network determined by the coverage area of the short-range radio transceiver; and means for determining a confidence level of the first device context by using the local context information of the first device and the received context information of the adhoc network.

The invention is based on the idea that context information contained by the devices belonging to a dynamic adhoc network is utilized in determining a confidence level of a single device context.

Several advantages are achieved with the method and the device of the invention. It enables determination of a confidence level of a context. The confidence level being high, the device can automatically, or with the assistance of a user, make decisions associated with the context. The determination of the confidence level of the context is decentralized processing, from which the devices belonging to a dynamic adhoc network benefit.

### LIST OF DRAWINGS

In the following, the invention will be described in greater detail in connection with preferred embodiments, with reference to the attached drawings, wherein

FIG. 1 is a simplified block diagram illustrating the structure of a portable electronic device and communication between a first electronic device and second electronic devices;

FIGS. 2A, 2B, 2C and 2D constitute an example that illustrates context determination by means of a dynamic adhoc network;

FIG. 3 illustrates context information obtained by sensors of the portable electronic device;

FIG. 4 is a flow chart illustrating the method for determining the context of the portable electronic device.

### DESCRIPTION OF THE EMBODIMENTS

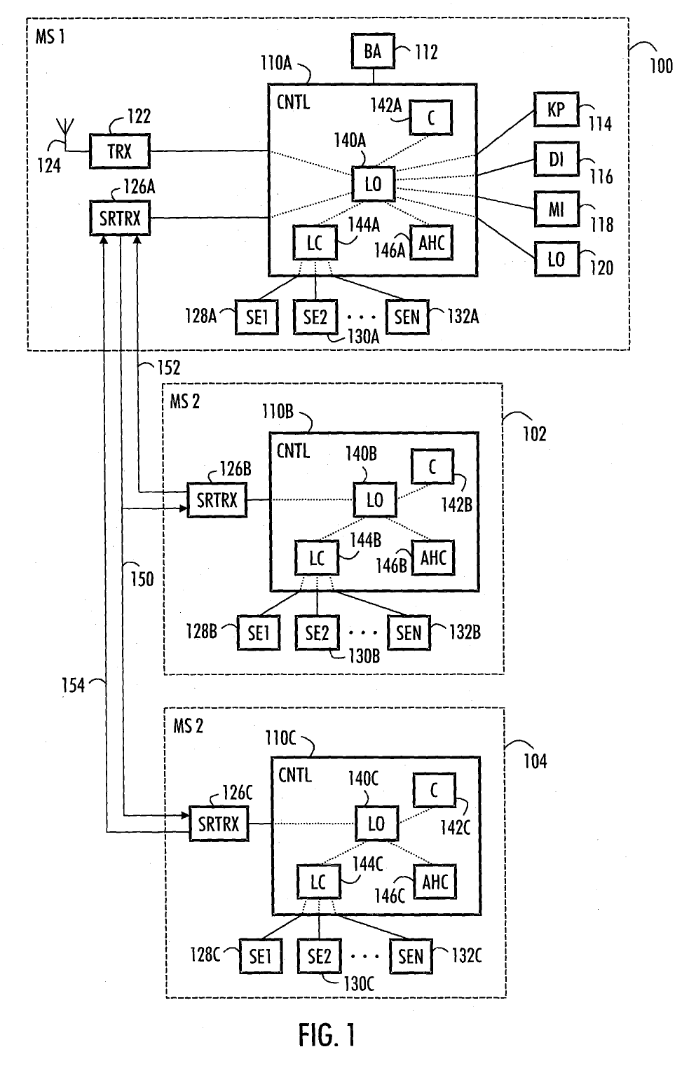

With reference to FIG. 1, an example of the structure of a portable electronic device is described. The portable electronic device can be a portable device relating to ubiquitous computing, for instance a subscriber terminal in a radio system, such as mobile system, a PDA (Personal Digital Assistant) device or a wearable device. The device may also combine various roles, i.e. it may be e.g. a combination of a subscriber terminal and a PDA device, the Nokia®Communicator® being one example of such devices.

FIG. 1 shows a first portable electronic device 100 and second portable electronic devices 102, 104. It should be noted that the structures of the first device 100 and the second device 102, 104 need not necessarily be different but the terms the first and the second only illustrate the role of the devices in the processing of context information. Thus, the first device 100 and the second device 102, 104 generally have the same structure, even though the structure of the second devices 102, 104 is not depicted in full in FIG. 1. Even though only one first device 100 and two second devices 102, 104 are described in the examples, it is apparent that there may also be more than two second devices 102, 104.

In our example, the devices 100, 102, 104 are subscriber terminals in a radio system, the device comprising an antenna 124 and a radio transceiver 122. The radio transceiver 122 is e.g. a prior art mobile station transceiver, which operates e.g. in the GSM (Global System for Mobile Communications) system, the GPRS (General Packet Radio Service) system or the UMTS (Universal Mobile Telecommunications System).

In addition, the device 100, 102, 104 comprises a short-range radio transceiver 126A, 126B, 126C, one example of which is an integrated circuit of Bluetooth technology, by which it is possible to implement a radio connection having a range of a few hundred metres at most, at the frequency of 2.4 gigahertz. A major advantage with using the Bluetooth is that the frequency band can be used free of charge. The short-range radio transceiver 126A, 126B, 126C can also be implemented by other known techniques.

A typical device 100, 102, 104 comprises a keypad 114, a display 116, a microphone 118 and a loudspeaker 120 for implementing a user interface. The power source is generally a rechargeable battery 112.

For context detection, the device 100, 102, 104 comprises various sensors 128A, 130A, 132A, 128B, 130B, 132B, 128C, 130C, 132C. The sensors include, for instance, a sensor measuring temperature, a sensor measuring air humidity, a sensor measuring ambient lightness, a sensor measuring ambient noise level and frequencies of the noise, a sensor measuring the user's heart rate, a sensor measuring the user's blood pressure, a sensor measuring the user's body temperature, a sensor monitoring the position of the device, a sensor measuring velocity of the device and a sensor detecting the device being touched. The sensor can also be any other prior art sensor, by which it is possible to measure properties necessary for context formation. The sensors generally produce a multidimensional, continuous signal vector, from which advantageous features can be generated. The multidimensional feature vectors can be quantized, for instance, by using fuzzy logic, which results in continuous and/or discrete context vectors. Contexts and portions of context can also be obtained from local www (World-Wide Web) services.

On the basis of the data of several, individual context vectors it is possible to generate a complex context representing a situation, where the device is used. The device 100, 102, 104 comprises a control unit 110A, 110B, 110C, which controls and monitors the operation of the device and the various parts thereof. Currently, the control unit 110A, 110B, 110C is generally implemented as a processor with software, but different equipment implementations are also possible, such as a circuit made of separate logic components, or one or more application-specific integrated circuits (ASIC). Combination of these different implementations is also possible. When selecting an implementation, a person skilled in the art considers, for example, the requirements set for the size and power consumption of the device, necessary processing performance, manufacturing costs and production volumes.

FIG. 1 shows data and functionalities included in the control unit 110A, 110B, 110C in principle. The control unit 110A, 110B, 110C thus comprises a context 142A, 142B, 142C, which is the currently valid context data in the device. The context 142A, 142B, 142C can be a simple, individual context data item, or it can be more complex context data based on a plurality of individual context data items.

In addition, the control unit 110A, 110B, 110C comprises local context information 144A, 144B, 144C of the device.

The control unit 110A, 110B, 110C also comprises a logic unit 140A, 140B, 140C, in which the operations relating to the context processing are performed.

So far, the structures of the first device 100 and the second devices 102, 104 have been described in a static state. In order to be able to illustrate the effect of a dynamic adhoc network on the operation of the devices, we have to change our observation viewpoint of the first device 100 into dynamic observation.

The first device 100 thus has a valid context 142A and, in addition, local context information 144A. The local context information 144A is the current context conceptualized by the device 100. The valid context 142A and the local context information 144A are not necessarily the same at the moment of observation, because the valid context 142A was decided on at a previous moment and the local context information 144A may contain more recent information on the actual context.

The dynamic temporary network, i.e. the so-called adhoc network, defined by the coverage area of the short-range radio transceiver 126A of the first device 100 comprises second devices 102, 104. Controlled by a logic unit 140A, the short-range radio transceiver receives context information 152, 154 transmitted by the second portable electronic device 102, 104 in the dynamic adhoc network.

The logic unit 140A then determines the confidence level of the context of the first device 100 by using the local context information of the first device 100 and the received context information 152, 154 of the adhoc network. The context information 152, 154 transmitted by the second device 102, 104 can be the local context information 144B, 144C of the second device 102, 104, or the context information 146B, 146C of the adhoc network of the second device 102,104.

In an embodiment, the logic unit 140A of the first device 100 automatically determines the context 142A if the confidence level exceeds a predetermined threshold value for the confidence level. In that case the confidence level is so high that there is only a minor chance to select a wrong context. If the confidence level is below a predetermined threshold value for the confidence level, the logic unit 142A determines the context by means of operations performed by the user interface 114, 116, 118. Typically, the situation can be such that the operations performed by the user interface 114, 116, 118, 120 comprise a selection from at least two different contexts proposed by the device. In that case the confidence level is still so high that this kind of semi-automatic context determination is possible. If the confidence level is very low, it may be necessary to increase the number of proposed alternatives. The context 142A may determine the user interface adaptation of the first device 100 and/or the information provided by the first device 100, and/or the service provided by the first device 100.

In an embodiment, the control unit 110A, 110B, 110C comprises the context information 146A, 146B, 146C of the adhoc network. The logic unit 140A of the first device 100 examines the local context information 144A of the first device 100 and/or the context information 146A of the first device adhoc network, and if a predetermined condition is fulfilled, sends a request 150 to the second electronic device 102,104 in the adhoc network to forward its context information to the first device 100. The first device 100 then receives the context information 152, 154 transmitted by each second device in succession. Then, the logic unit of the first device 100 updates the context information 146A of the adhoc network of the first device by using the context information 152, 154 received from the second devices 102, 104.

In an embodiment said predetermined condition is fulfilled if the similarity between the local context information 144A of the first device 100 and the context information 146A of the adhoc network of the first device 100 is below a predetermined similarity threshold value.

In an embodiment said predetermined condition is fulfilled if the stability of the local context information 144A of the first device 100 is below a predetermined stability threshold value. The stability can be determined by using a long-term average and the valid value of the local context information 144A of the first device 100.

For the sake of clarity, it should be noted that the context information, either the local context information or the context information of the adhoc network, comprises at least one of the following: user context, environment context, device context.

In an embodiment the logic unit 140A and the short-range radio transceiver 126A of the first device 100 transmit the context information 146A of the adhoc network of the first device 100 to the second device 102, 104 after the update of the context information 146A of the adhoc network of the first device 100.

In an embodiment the logic unit 140A of the first device 100 updates the local context information 144A of the first device 100 in connection with the update of the context information 146A of the adhoc network of the first device.

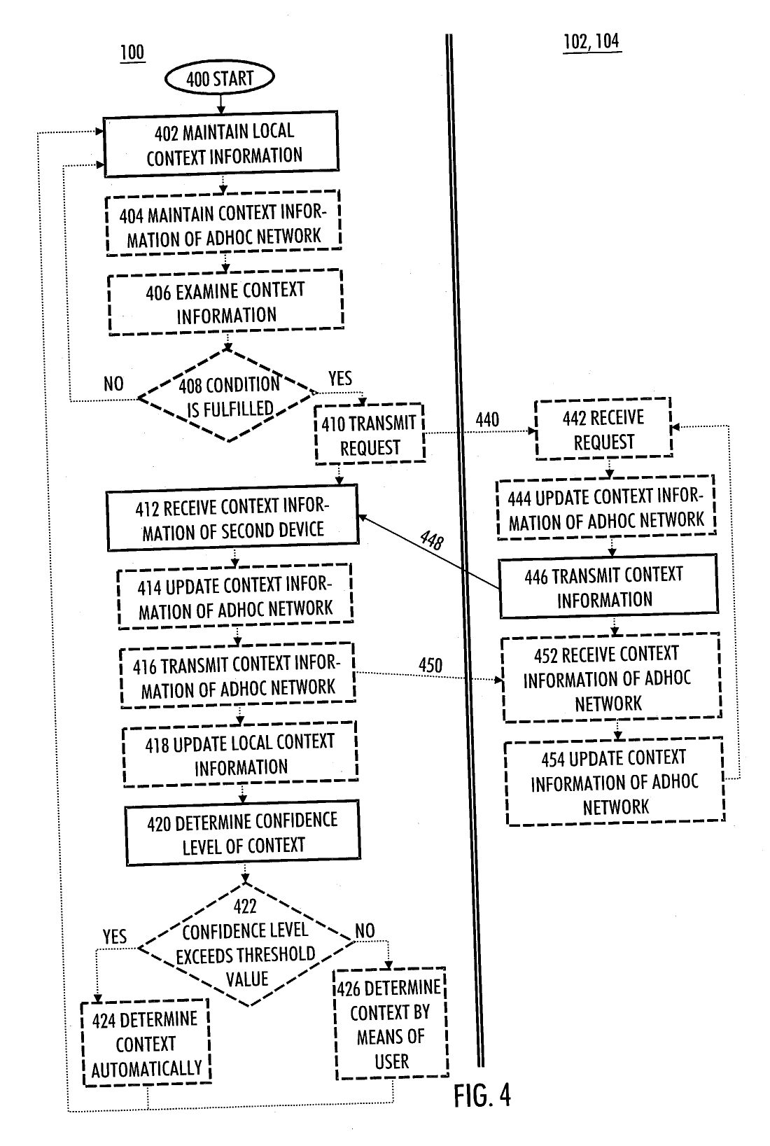

In an embodiment the request 150 transmitted by the first device 100 comprises the local context information 144A of the first device 100. This also enables the second devices 102, 104 to benefit from the operation of the dynamic adhoc network. This will be described in greater detail later on in the text, in connection with FIG. 4.

The logic unit 140A, 140B, 140C, the context 142A, 142B, 142C, the local context information 144A, 144B and 144C and the adhoc network context information 146A, 146B, 146C comprised by the control unit 110A, 110B, 110C are thus advantageously implemented by means of software, and consequently said functionalities and data items are implemented as program modules and data structures, but apparatus implementation, for instance as an ASIC, is also possible.

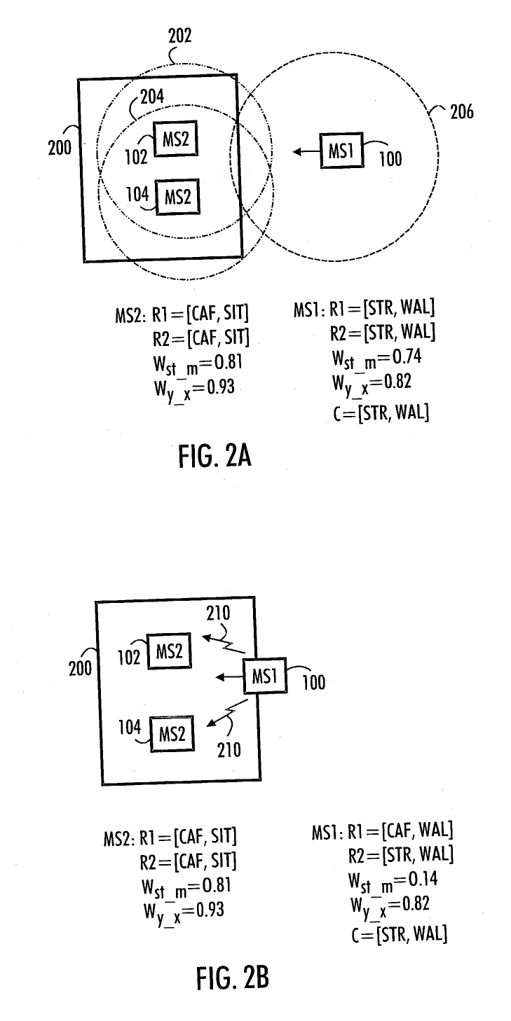

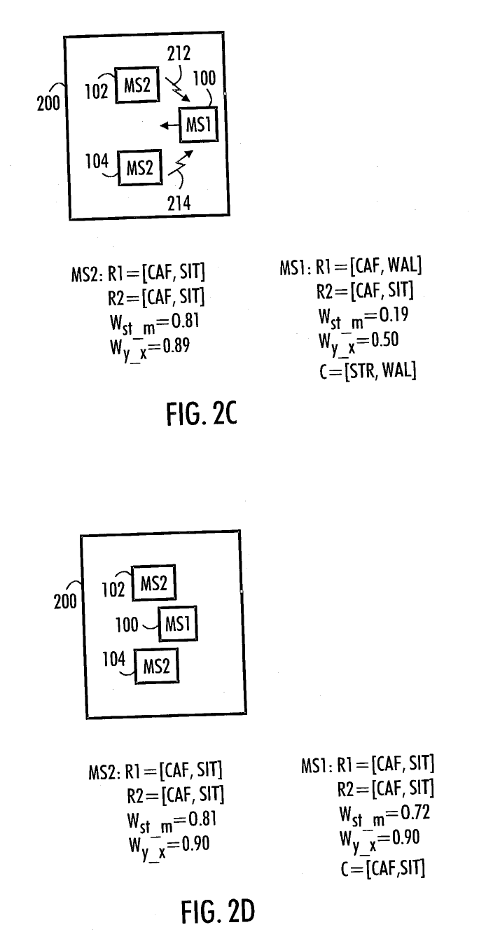

Next, the flow chart of FIG. 4 illustrates the method for determining the context of a portable electronic device. The left side of FIG. 4 describes the operations to be performed in the first device 100 and the right side those to be performed in the second devices 100, 102. The blocks and the transition arrows drawn in broken lines show the optional embodiments of the method. At the same time, reference is made to the example of FIGS. 2A, 2B, 2C and 2D, which illustrates context determination by means of a dynamic adhoc network.

The method starts in 400, typically, when a first device 100 is switched on.

Then, in 402, local context information is maintained in the first portable electronic device 100. Mathematically, the local context information can be presented as a context vector of the device m at a time instant n

Xₘ(n)=[x₁, . . . , xₖ], (1)

where there are k individual elements. To facilitate the mathematical processing, the elements can be scaled between [0,1].

In an embodiment, the process proceeds to 404, where the context information of the adhoc network of the first device is maintained in the first device 100. The context register of the adhoc network can be expressed

Yₘ(n)=[y₁, . . . , yₖ], (2)

where there are as many elements as in vector 1, in the same order, and in addition, the elements of vector 2 are also scaled between [0,1].

In optional 406, the local context information of the first device 100 and/or the context information of the adhoc network of the first device are examined. The stability of the local context information of the first device 100 can be determined using a long-term average and the valid value of the local context information of the first device 100. The stability of the local context information can be determined as follows:

$${w}_{st\_m} ( n ) = {ⅇ}^{- ( A {\sum }_{i = 1}^{k} ( {\overline{X}}_{{m}_{i}} ( n ) - {X}_{{m}_{i}} ( n ) ) )} , \qquad ( 3 )$$

where the sum inside the brackets is a vector distance measure, and A is a changing/adaptive scaling parameter for a slope and it depends on the variance of the distances. The stability of the local context information is scaled between [0,1] using a Gaussian kernel.

The similarity between the local context information of the first device and the context information of the adhoc network of the first device can be determined as follows:

$${w}_{Y\_X} ( n ) = {ⅇ}^{- ( B {\sum }_{i = 1}^{k} ( {Y}_{{m}_{i}} ( n ) - {X}_{{m}_{i}} ( n ) ) )} , \qquad ( 4 )$$

where B is a changing/adaptive scaling parameter.

In optional 406, the examination results are compared with the predetermined conditions. In an embodiment the predetermined condition is fulfilled if the similarity between the local context information of the first device and the context information of the adhoc network of the first device is below the predetermined similarity threshold value. In an embodiment, the predetermined condition is fulfilled if the stability of the local context information of the first device is below the predetermined stability threshold value. These two embodiments can be expressed as follows:

w_{st—m}<thr_1 OR w_{Y—X}<thr_2 (5)

If neither of the conditions described in 5 is fulfilled, the process proceeds from 408 to 402, otherwise the process proceeds to optional 410, where, the predetermined condition being fulfilled, a request 440 is transmitted to a second electronic device 102, 104 in the adhoc network to forward its context information to the first device 100.

FIG. 2A is now studied, in which the first device 100 is seen to move along the street in the direction of an arrow towards a café 200, where the second devices 102, 104 are. The coverage area 206 of the short-range radio transceiver of the first device 100 is coming closer to the second devices 102, 104, and naturally at the same time, the first device is entering the coverage area 202 of the short-range radio transceiver of the second device 102 and the coverage area 204 of the short-range radio transceiver of the second device 104. The local context vector R1 of the first device 100 includes an element STR that represents being in the street and an element WAL that represents walking, and the context vector R2 of the adhoc network of the first device 100 also includes the elements STR and WAL. The value of the stability w_{st—m} of the local context information of the first device 100 is 0.74 and the value of the similarity w_{y—x} between the local context information and the context information of the adhoc network is 0.82. The valid context C of the first device includes the elements STR and WAL.

The local context vector R1 of the second device 102, 104 includes an element CAF that represents being in the café and an element SIT that represents sitting, and the context vector R2 of the adhoc network of the second device 102, 104 includes an element CAF that represents being in the café and an element SIT that represents sitting. The value of the stability w_{st—m} of the local context information of the second device 102, 104 is 0.81 and the value of the similarity w_{y—x} between the local context information and the context information of the adhoc network is 0.93.

For instance, if the value of thr_1 is 0.6 and the value of thr_2 is 0.6, neither of the conditions described in 5 is fulfilled in FIG. 2A. In FIG. 2B, the situation has developed such that a person having the first device 100 on him has entered the café 200. The sensors of the first device 100 have detected changes in temperature, air humidity and noise level, for instance. So the first element of the local context vector R1 of the first device 100 has changed into the element CAF that represents being in the café, but the second element is still WAL that represents walking, because the person is still walking. The content of the context vector R2 of the adhoc network of the first device 100 is still unchanged, i.e. it includes the elements STR and WAL. The value of the stability w_{st—m} of the local context information of the first device 100 is dropped to 0.14, because it was determined using the long-term average of the local context information of the first device 100 and the latest value of the local context information of the first device 100, for instance in accordance with Formula 3. The value of the similarity w_{y—x} between the local context information of the first device 100 and the context information of the adhoc network is still 0.82. Likewise, the valid context C of the first device 100 still includes the elements STR and WAL. The local context vector R1 of the second device 102, 104 and the context vector R2 of the adhoc network have not been changed from the situation in FIG. 2A, nor have the w_{st—m} and w_{y—x} of the second device been changed.

The condition described in Formula 5 is thus fulfilled in FIG. 2B, because w_{st—m}=0.14<thr_1 (which is assumed to be 0.6 in our example). Consequently, the process proceeds from 408 to 410, where a request 440 to forward the context information to the first device 100 is transmitted to the second electronic device 102, 104 of the adhoc network. A process shown on the right of the vertical line in FIG. 4 is performed in each second device 102, 104 belonging to the adhoc network.

As appears from FIG. 4, the transmission of the request 440 is optional. It is possible to use also other mechanisms, by which the need for update is detected. If the request mechanism is used, the request 440 is received in 442. Then, the second device 102, 104 forwards its context information 448 to the first device 100 in 446.

In an embodiment the request 440 comprises the local context information of the first device 100. Thus, the second device 102, 104 updates its local context information using the received local context information of the first device 100. This can be carried out, for instance, such that first is calculated the similarity between the local context information of the first device 100 and the context information of the adhoc network of the second device 102, 104 by

$${w}_{{X}_{1} {\_Y}_{m}} ( n ) = {ⅇ}^{- ( C {\sum }_{i = 1}^{k} ( {X}_{{1}_{i}} ( n ) - {Y}_{{m}_{i}} ( n ) ) )} , \qquad ( 6 )$$

where C is a changing/adaptive scaling parameter. Thereafter, it is possible to calculate for the second device 102, 104 new adhoc network context information weighted by the calculated similarity:

$${Y}_{m}^{′} ( n ) = \frac{{X}_{1} {w}_{{X}_{1} {\_Y}_{m}} + {Y}_{m} {w}_{Y\_X}}{{w}_{{X}_{1} {\_Y}_{m}} + {w}_{Y\_X}} \qquad ( 7 )$$

The context information 448 transmitted by the second device in 446 can thus comprise the context information of the adhoc network of the second device 102, 104, formed by Formula 7, for instance. Alternatively, the context information 448 transmitted by the second device 102, 104 may also comprise the local context information of the second device 102, 104.

Next, in 412, the context information 448 transmitted by the second device 102, 104 belonging to the dynamic adhoc network determined by the coverage area of the short-range radio transceiver of the first device 100 is received in the first device 100.

In optional 414, the context information of the adhoc network of the first device 100 is then updated by using the context information 448 received from the second electronic device 102, 104. If the number of the adhoc network devices 100, 102, 104 is m, then the number of second devices 102, 104 is m−1. Thus, m−1 pieces of context information of the second devices 102, 104 are received, for instance, the adhoc network context information Y′ₘ(n) of the second device 102, 104. The average of the pieces of the context information of the adhoc network, including Yₘ(n) of the first device 100, is then

$${\overline{Y}}_{m}^{′} ( n ) = \frac{1}{m} {\sum }_{i = 0}^{m} {Y}_{m}^{′} ( n ) \qquad ( 8 )$$

The weighting coefficients for each Y′ by using distances to a mean point is

$${w}_{{\overline{Y}}_{m}^{′}} ( n ) = {ⅇ}^{- ( D {\sum }_{i = 1}^{k} {\overline{Y}}_{{m}_{i}}^{′} ( n ) - {Y}_{m}^{′} ( n ) )} , ∀ i = 1 , … , m , \qquad ( 9 )$$

where D is a changing/adaptive scaling parameter. It is then possible to calculate new context information of the adhoc network of the first device 100 by using a weighted average

$${Y}^{″} ( n ) = \frac{{\sum }_{i = 1}^{m} {w}_{i {\overline{Y}}_{i}^{′}} , {Y}_{i}^{′}}{{\sum }_{i = 1}^{m} {w}_{i {\overline{Y}}^{′}}} \qquad ( 10 )$$

In an embodiment, after the update of the context information of the adhoc network of the first device 100 in 414, the adhoc network context information 450 of the first device 100 is transmitted to the second device 102, 104 at 416. In 452, the second device 102, 104 then receives the context information 450 of the adhoc network transmitted by the first device 100. In 454 the second device 102, 104 updates the adhoc network context information of its own. First is calculated the similarity between the context information of the adhoc network of the second device 102, 104 and the context information of the adhoc network received from the first device 100

$${w}_{{Y}_{{m\_Y}^{*}}^{′}} ( n ) = {ⅇ}^{- ( E {\sum }_{i = 1}^{k} ( {Y}_{{m}_{i}}^{′} ( n ) - {Y}^{*} ( n ) ) )} , \qquad ( 11 )$$

where E is a changing/adaptive scaling parameter. Thereafter is calculated new context information of the adhoc network of the second device 102, 104 by using a weighted average.

$${Y}_{m}^{′} ( n ) = \frac{{Y}^{″} {w}_{{Y}_{m\_ }^{′} {Y}^{*}} + {Y}_{m} {w}_{Y\_X}}{{w}_{{Y}_{m\_ }^{′} {Y}^{*}} + {w}_{Y\_X}} \qquad ( 12 )$$

Then, w_{Y—X} is updated using Formula 4. In the second device 102, 104, a transition from 454 to 442 is made from the viewpoint of the first device 100.

Now we have a situation according to FIG. 2C, where the user of the first device 100 has entered the café and walks towards a table, at which the users of the second devices 102, 104 are sitting. The local context vector R1 of the first device 100 now, after the update, includes the elements CAF and WAL, and the adhoc network context vector R2 of the first device 100 includes the elements CAF and SIT after the update carried out by means of the adhoc network. The value of the stability w_{st—m} of the local context information of the first device 100 is still relatively low 0.19, and the value of the similarity between the local context information and the context information of the adhoc network is 0.50. The valid context C of the first device still includes the elements STR and WAL.

The local context vector R1 of the second device 102, 104 still includes the elements CAF and SIT, and the adhoc network context vector R2 of the second device 102, 104 includes the elements CAF and SIT despite the update. The value of the stability w_{st—m} of the local context information of the second device 102, 104 is still 0.81, but the value of the similarity between the local context information and the context information of the adhoc network has decreased slightly to 0.89.

In an embodiment, in 418, the local context information of the first device 100 is also updated in connection with the update of the adhoc network context information of the first device 100.

At 420 is determined the confidence level of the context of the first device 100 by using the local context information and the received adhoc network context information of the first device 100. In practice, the local context information that the first device 100 has detected by its own sensors is compared with the received adhoc network context information that is possibly treated in the above-described manner using Formulas 8, 9 and 10. For instance, Formula 4 can be applied to the comparison.

In 422, the determined confidence level is then compared with the predetermined threshold value. If the confidence level exceeds the threshold value, it is possible to proceed to 424, where the first device 100 automatically determines its context. Whereas, if the confidence level is below the predetermined threshold value for the confidence level, 426 is proceeded to, where the first device 100 determines its context by using the user interface operations of the first device 100. The user interface operations may comprise a selection from at least two different contexts proposed by the first device 100. Finally, both from 424 and from 426 the process returns back to 402.

FIG. 4 does not describe termination of the method, because, in principle, it can be terminated at any point, for instance when the first device 100 is switched off. The device of the type described above is applicable for performing the method, but also other devices can be applied to implement the method.

In the example of FIG. 2C, the confidence level is not yet sufficiently high, and therefore the valid context information of the first device 100 will not be changed. In FIG. 2D, the situation has developed. The first device 100 has restarted the context determination by means of the adhoc network, and the local context information of the first device 100 has remained the same quite a long time, and it is the same as the context information of the adhoc network of the first device 100, whereby the value of w_{st—m} has increased to 0.72 and the value of w_{y—x} to 0.90, and it has been possible to change the valid context value C to be the last value of the local context information, i.e. it includes the elements CAF and SIT.

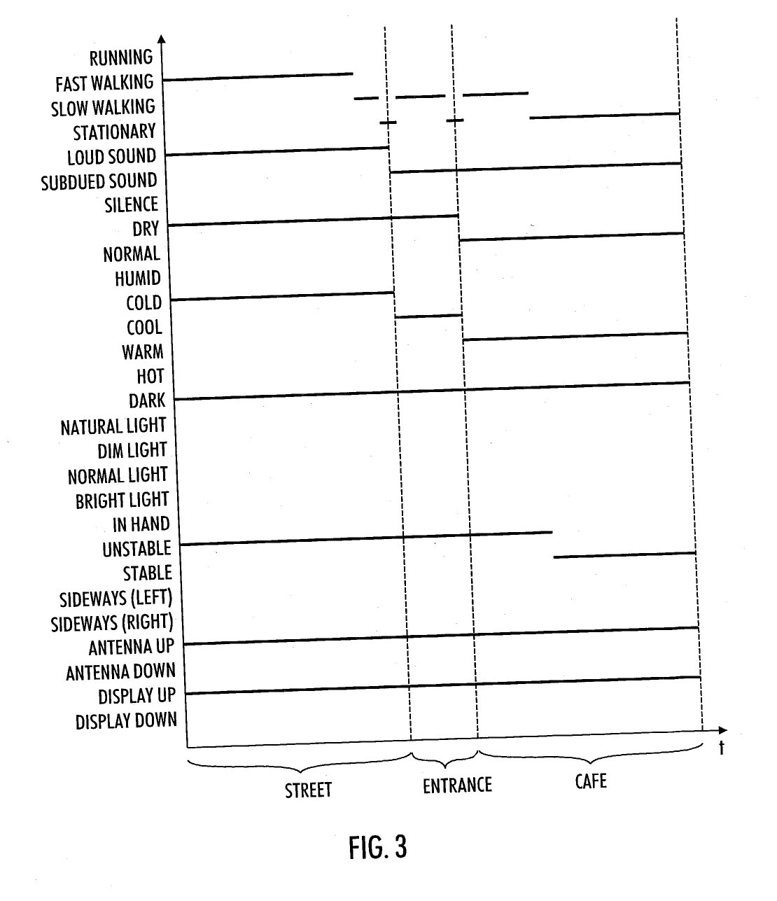

FIG. 3 illustrates the context data provided by the sensors of the first device 100. The sensors provide data, represented on X-axis, on the movement (running, fast walking, slow walking, stationary), noise level (loud sound, subdued sound, silence), air humidity (dry, normal, humid), air temperature (cold, cool, warm, hot), lightness (dark, natural light, dim light, normal light, bright light) and location of the device (in hand, unstable, stable, sideways (left), sideways (right), antenna up, antenna down, display up, display down). The Y-axis represents time. With reference to the example of FIGS. 2A, 2B, 2C and 2D, the location of the first device 100 is marked on the Y-axis. First the user of the device walked along the street (fast walking, loud sound, dry, cold, dark, unstable, antenna up, display up), then (s)he arrived in the entrance hall of a café (stationary, slow walking, subdued sound, dry, cool, dark, unstable, antenna up, display up) and finally (s)he entered the café (slow walking, stationary, normal, warm, dark, stable, antenna up, display up). The first device 100 is all the time in the pocket, and therefore it is dark without interruption, the antenna is up and the display is up. This also illustrates that the information provided by the sensors may be contradictory or even wrong. The context information of the adhoc network contributes to infer the reliability of the information, which enables even an automatic context change.

Even though the invention is described above with reference to the example of the attached drawings, it is apparent that the invention is not restricted thereto but it can be modified in a variety of ways within the scope of the inventive idea set forth in the accompanying claims.

1. A method for determining a context of a portable electronic device, the method comprising:
maintaining local context information in a first portable electronic device;
receiving in the first electronic device context information transmitted by a second portable electronic device belonging to a dynamic adhoc network determined by the coverage area of a short-range radio transceiver of the first device; and
determining a confidence level of the first device context by using the local context information of the first device and the received context information of the adhoc network.

2. A method as claimed in claim 1, further comprising:
if the confidence level exceeds a predetermined threshold value for the confidence level, the first device automatically determines its own context.

3. A method as claimed in claim 1, further comprising:
if the confidence level is below a predetermined threshold value for the confidence level, the first device determines its own context by using user interface operations of the first device.

4. A method as claimed in claim 3, wherein the user interface operations comprise a selection from at least two different contexts proposed by the first device.

5. A method as claimed in claim 1, wherein the context information transmitted by the second device comprises local context information of the second device.

6. A method as claimed in claim 1, wherein the context information transmitted by the second device comprises the context information of the adhoc network of the second device.

7. A method as claimed in claim 1, wherein the context determines at least one of the following: user interface adaptation of the first device, information provided by the first device, service provided by the first device.

8. A method as claimed in claim 1, wherein the context information comprises at least one of the following: user context, environment context, device context.

9. A method as claimed in claim 1, further comprising:
maintaining in the first device the context information of the adhoc network of the first device;
examining the local context information of the first device and/or the context information of the adhoc network of the first device, and if the predetermined condition is fulfilled, a request is transmitted to the second device to forward its context information to the first device; and
updating the context information of the adhoc network of the first device by using the context information received from the second electronic device.

10. A method as claimed in claim 9, further comprising:
transmitting the context information of the adhoc network of the first device to the second device after the context information update of the adhoc network of the first device.

11. A method as claimed in claim 9, further comprising:
updating also the local context information of the first device in connection with the update of the adhoc network context information of the first device.

12. A method as claimed in claim 9, wherein the request comprises the local context information of the first device, whereby the second device updates its local context information using the received local context information of the first device.

13. A method as claimed in claim 9, wherein the predetermined condition is fulfilled if the similarity between the local context information of the first device and the context information of the adhoc network of the first device is below the predetermined similarity threshold value.

14. A method as claimed in claim 9, wherein the predetermined condition is fulfilled if the stability of the local context information of the first device is below the predetermined stability threshold value.

15. A method as claimed in claim 14, wherein the stability is determined using a long-term average and the valid value of the local context information of the first device.

16. A portable electronic device comprising:
a user interface;
a context;
means for maintaining local context information of a first device;
a short-range radio transceiver;
means for receiving context information transmitted by a second portable electronic device belonging to a dynamic adhoc network determined by the coverage area of the short-range radio transceiver; and
means for determining a confidence level of the first device context by using the local context information of the first device and the received context information of the adhoc network.

17. A device as claimed in claim 16, further comprising means for automatically determining its context if the confidence level exceeds the predetermined threshold value for the confidence level.

18. A device as claimed in claim 16, further comprising means for determining its context using user interface operations if the confidence level is below the predetermined threshold value for the confidence level.

19. A device as claimed in claim 18, wherein the user interface operations comprise a selection from at least two different contexts proposed by the device.

20. A device as claimed in claim 16, wherein the context information transmitted by a second device comprises the local context information of the second device.

21. A device as claimed in claim 16, wherein the context information transmitted by a second device comprises the context information of the adhoc network of the second device.

22. A device as claimed in claim 16, wherein the context determines at least one of the following: user interface adaptation of the first device, information provided by the first device, service provided by the first device.

23. A device as claimed in claim 16, wherein the context information comprises at least one of the following: user context, environment context, device context.

24. A device as claimed in claim 16, further comprising
means for maintaining the context information of the adhoc network of the first device;
means for examining the local context information of the first device and/or the context information of the adhoc network of the first device, and if the predetermined condition is fulfilled, transmitting a request to a second electronic device of the adhoc network to forward its context information to the first device; and
means for updating the adhoc network context information of the first device by using the context information received from the second electronic device.

25. A device as claimed in claim 24, further comprising
means for transmitting the context information of the adhoc network of the first device to the second device after the update of the adhoc network context information of the first device.

26. A device as claimed in claim 24, further comprising
means for updating the local context information of the first device in connection with the update of the adhoc network context information of the first device.

27. A device as claimed in claim 24, wherein the request comprises the local context information of the first device.

28. A device as claimed in claim 24, wherein the predetermined condition is fulfilled if the similarity between the local context information of the first device and the adhoc network context information of the first device is below the predetermined similarity threshold value.

29. A device as claimed in claim 24, wherein the predetermined condition is fulfilled if the stability of the local context information of the first device is below the predetermined stability threshold value.

30. A device as claimed in claim 29, wherein the stability is determined by using a long-term average and the valid value of the local context information of the first device.
